(19) United States
(12) Patent Application Publication
(10) Pub. No.: US 2024/0421696 A1
(43) Pub. Date: Dec. 19, 2024

(54) SHORT CIRCUIT MITIGATION IN A POWER TOOL

(71) Applicant: MILWAUKEE ELECTRIC TOOL CORPORATION, Brookfield, WI (US)

(72) Inventors: Matthew C. Noel, Fond du Lac, WI (US); Thomas Goltz, Hartford, WI (US); Logan Manderle, Milwaukee, WI (US); Erik P. Bothe, Pewaukee, WI (US)

(21) Appl. No.: 18/703,764

(22) PCT Filed: Dec. 14, 2022
(86) PCT No.: PCT/US2022/081546

§ 371 Date: Apr. 23, 2024

Related U.S. Application Data
(60) Provisional application No. 63/325,339, filed on Mar. 30, 2022.
(60) Provisional application No. 63/289,428, filed on Dec. 14, 2021.

(51) Int. Cl. H02M 1/32; B25D 16/00; H01M 50/247; H02M 1/00; H02M 1/088; H02M 1/36; H02P 3/08

(52) U.S. Cl. CPC H02M 1/32; H02M 1/0009; H02M 1/0025; H02M 1/088; H02M 1/36; H02P 3/08; B25D 16/00; B25D 2216/0069; H01M 50/247

(57) ABSTRACT

Power tools that include a housing, a motor supported by the housing, a battery pack interface configured to receive a battery pack that includes a plurality of battery cells, an inverter positioned between and electrically connected to the battery pack interface and the motor, a gate driver connected to the inverter and configured to control a current in the inverter, a controller configured to control the gate driver, and a short circuit detection circuit. The short circuit detection circuit is configured to monitor the current in the inverter, compare the current in the inverter to a short circuit threshold, and control a switch of the short circuit detection circuit to disable the gate driver when the current in the inverter is greater than or equal to the short circuit threshold.

### RELATED APPLICATIONS

This application claims the benefit of U.S. Provisional Patent Application No. 63/289,428, filed Dec. 14, 2021, and U.S. Provisional Patent Application No. 63/325,339, filed Mar. 30, 2022, the entire content of each of which is hereby incorporated by reference.

### FIELD

Embodiments described herein relate to controlling a motor of a power tool.

### SUMMARY

Power tools include circuitry configured to control a motor of the power tool. To prevent damage to the motor and power electronics and expand the lifetime of the power tool, circuitry to detect and prevent harmful conditions, such as short-circuits, can be incorporated into the power tool.

Power tools described herein include a housing, a motor supported by the housing, a battery pack interface configured to receive a battery pack that includes a plurality of battery cells, an inverter positioned between and electrically connected to the battery pack interface and the motor, a gate driver connected to the inverter and configured to control a current in the inverter, a controller configured to control the gate driver, and a short circuit detection circuit. The short circuit detection circuit is configured to monitor the current in the inverter, compare the current in the inverter to a short circuit threshold, and control a switch of the short circuit detection circuit to disable the gate driver when the current in the inverter is greater than or equal to the short circuit threshold.

In some aspects, the short circuit detection circuit includes a threshold adjuster for adjusting the short circuit threshold.

In some aspects, the battery pack interface is configured to receive a first power tool battery pack and a second power tool battery pack.

In some aspects, the first power tool battery pack and the second power tool battery pack are configured to be connected in series.

In some aspects, the short circuit detection circuit further includes an overcurrent condition comparator and an undervoltage condition comparator.

In some aspects, the short circuit detection circuit is further configured to provide a signal to the controller when the current in the inverter is greater than or equal to the short circuit threshold.

In some aspects, the short circuit detection circuit is further configured to monitor a voltage of the power tool, compare the voltage to an undervoltage threshold, and control a switch of the short circuit detection circuit to disable the gate driver when the voltage is less than or equal to the undervoltage threshold.

In some aspects, the short circuit detection circuit is further configured to disable the gate driver for a period of time after the current in the inverter is greater than or equal to the short circuit threshold.

In some aspects, the short circuit detection circuit is further configured to latch the gate driver active and unlatch the gate driver to disable the gate driver.

In some aspects, the short circuit detection circuit is further configured to monitor a second current related to the battery pack, monitor a third current related to the battery pack, control the switch of the short circuit detection circuit to disable the gate driver when the second current is greater than or equal to the short circuit threshold, and control the switch of the short circuit detection circuit to disable the gate driver when the third current is greater than or equal to the short circuit threshold.

Methods for short circuit detection in a power tool described herein include measuring, with a current sensor, a current in the inverter, receiving a fault signal related to a fault condition of the gate driver or inverter of the power tool (e.g., a short circuit condition), adjusting, with a threshold adjuster, a fault threshold based on the fault signal to generate a short circuit fault threshold, comparing the current in the inverter to the short circuit fault threshold to identify the short circuit condition of the power tool, and disabling a gate driver of the power tool in response to identifying the short circuit condition.

In some aspects, the methods further include disabling a trigger signal of the power tool in response to identifying the short circuit condition of the power tool.

In some aspects, the methods further include disabling the gate driver of the power tool for a period of time after identifying the short circuit condition.

In some aspects, the methods further including latching the gate driver active, and unlatching the gate driver to disable the gate driver.

Methods for short circuit detection in a power tool described herein include receiving, at a first comparator, a first signal related to a current in the inverter, comparing, with the first comparator, the first signal to a first fault threshold, receiving, at a second comparator, a second signal related to a voltage of the power tool, comparing, with the second comparator, the second signal to a second fault threshold, disabling, using a switch, a gate driver of the power tool in response to the first signal being greater than or equal to the first fault threshold or the second signal being less than or equal to the second fault threshold.

In some aspects, the first threshold is a hardware overcurrent threshold.

In some aspects, the second threshold is an undervoltage threshold.

In some aspects, the methods further include disabling a trigger signal of the power tool in response the first signal being greater than or equal to the first fault threshold or the second signal being less than or equal to the second fault threshold.

Power tools described herein include a housing, a motor supported by the housing, and a battery pack interface configured to receive a battery pack. The battery pack includes a plurality of battery cells. The power tool further includes an inverter positioned between and electrically connected to the battery pack interface and the motor, a gate driver connected to the inverter, and a controller. The gate driver is configured to control a current in the inverter. The controller is configured to control the gate driver. A short circuit detection circuit is configured to determine a voltage related to the battery pack, determine a short circuit overcurrent threshold based on the voltage related to the battery pack, monitor the current in the inverter, compare the current in the inverter to the short circuit overcurrent threshold, and control a switch to disable the motor when the current in the inverter is greater than or equal to the short circuit overcurrent threshold.

In some aspects, the battery pack interface is configured to receive a first power tool battery pack and a second power tool battery pack.

In some aspects, the first power tool battery pack and the second power tool battery pack are configured to be connected in series.

In some aspects, the short circuit overcurrent threshold is selected from a plurality of stepped short circuit overcurrent thresholds based on the voltage related to the battery pack.

In some aspects, the voltage related to the battery pack is a direct current (“DC”) link bus voltage.

In some aspects, the short circuit detection circuit is further configured to start a timer after the current in the inverter is greater than or equal to the short circuit overcurrent threshold, compare the timer to a timer threshold, and control the switch of the short circuit detection circuit to disable the motor when the current in the inverter is greater than or equal to the short circuit overcurrent threshold and the timer is greater than or equal to the timer threshold.

Methods for short circuit detection in a power tool described herein include determining a voltage related to a battery pack connected to a battery pack interface of the power tool, determining a short circuit overcurrent threshold based on the voltage related to the battery pack, monitoring a current in an inverter of the power tool, comparing the current in the inverter to the short circuit overcurrent threshold, and controlling a switch to disable a motor of the power tool when the current in the inverter is greater than or equal to the short circuit overcurrent threshold.

In some aspects, the methods further include receiving a first power tool battery pack and a second power tool battery pack at the battery pack interface of the power tool.

In some aspects, the methods further include connecting the first power tool battery pack and the second power tool battery pack in series.

In some aspects, the methods further include selecting the short circuit overcurrent threshold from a plurality of stepped short circuit overcurrent thresholds based on the voltage related to the battery pack.

In some aspects, the voltage related to the battery pack is a direct current (“DC”) link bus voltage.

In some aspects, the methods further include starting a timer after the current in the inverter is greater than or equal to the short circuit overcurrent threshold, comparing the timer to a timer threshold, and controlling the switch to disable the motor when the current in the inverter is greater than or equal to the short circuit overcurrent threshold and the timer is greater than or equal to the timer threshold.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1A illustrates a side view of a power tool in accordance with some embodiments.

FIG. 1B illustrates a front view of a power tool in accordance with some embodiments.

FIG. 2 illustrates a block diagram of a control system of a power tool in accordance with some embodiments.

FIG. 3 illustrates a battery pack for use in a power tool in accordance with some embodiments.

FIG. 4 illustrates a block diagram of a control system of a battery pack in accordance with some embodiments.

FIG. 5 illustrates a block diagram of a short circuit detection system in accordance withs some embodiments.

FIG. 6 illustrates a block diagram of a short circuit detection system in accordance withs some embodiments.

FIG. 7 illustrates the circuitry of a short circuit detection system in accordance withs some embodiments.

FIG. 8 illustrates a process of performing short circuit mitigation using a short circuit detection system in accordance withs some embodiments.

FIG. 9 illustrates a block diagram of a short circuit detection system in accordance withs some embodiments.

FIG. 10A and FIG. 10B illustrate circuitry of a short circuit detection system in accordance with some embodiments.

FIG. 11A and FIG. 11B illustrate a process of performing short circuit mitigation using a short circuit detection system in accordance with some embodiments.

FIG. 12 illustrates a short circuit detection circuit in accordance with some embodiments.

FIG. 13 illustrates a short circuit threshold in accordance with some embodiments.

FIG. 14 illustrates a process for implementing short circuit mitigation in a power tool in accordance with some embodiments.

FIG. 15 illustrates a process for implementing short circuit mitigation in a power tool in accordance with some embodiments.

### DETAILED DESCRIPTION

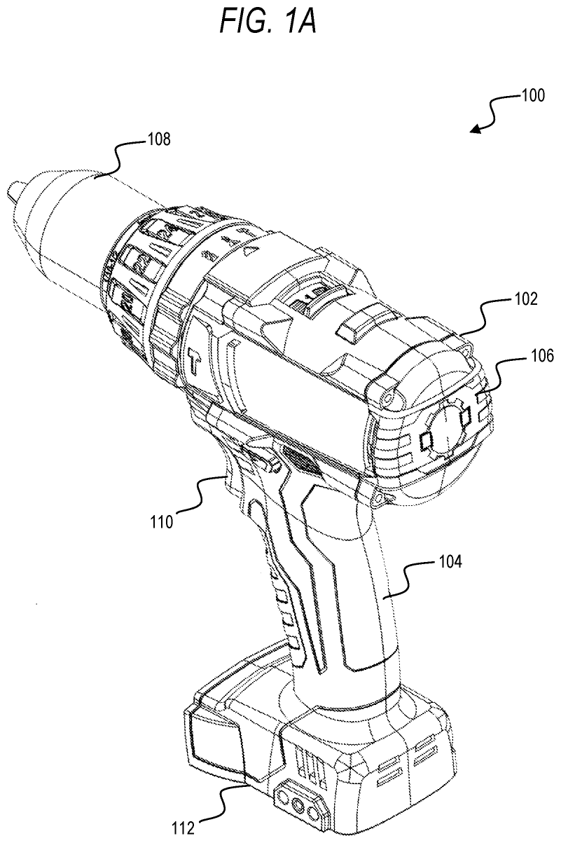

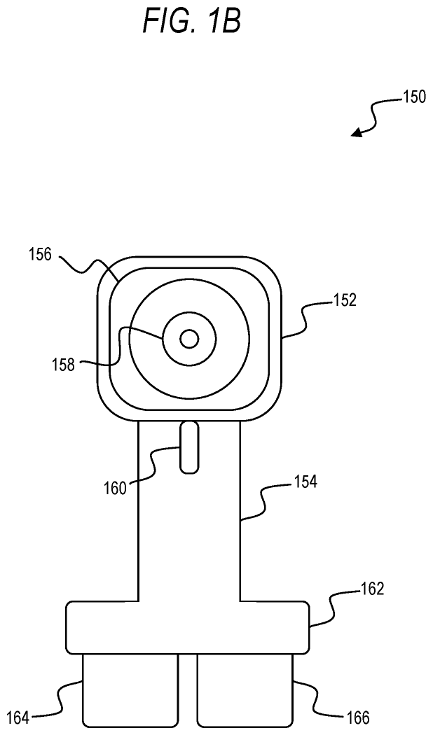

FIG. 1A illustrates a power tool 100 including a brushless direct current (“BLDC”) motor. The power tool 100 is, for example, a brushless hammer drill including a housing 102. The housing 102 includes a handle portion 104 and motor housing portion 106. The power tool 100 further includes an output driver 108 (illustrated as a chuck), trigger 110, and a battery pack interface 112. The battery pack interface 112 is configured to mechanically and electrically connect to a power tool battery pack. Although FIG. 1A illustrates a hammer drill, in some embodiments, the components described herein are incorporated into other types of power tools including drill-drivers, impact drivers, impact wrenches, angle grinders, circular saws, reciprocating saws, string trimmers, leaf blowers, vacuums, and the like. In a brushless motor power tool, such as power tool 100, switching elements are selectively enabled and disabled by control signals from a controller to selectively apply power from a power source (e.g., battery pack) to drive a brushless motor.

FIG. 1B illustrates a power tool 150 including a BLDC motor. The power tool 150 is, for example, a brushless hammer drill including a housing 152. The housing 152 includes a handle portion 154 and motor housing portion 156. The power tool 150 further includes an output driver 158 (illustrated as a chuck), trigger 160, and a battery pack interface 162. The battery pack interface 162 is configured to receive a plurality of battery packs, such as battery pack 164 and battery pack 166. Although FIG. 1B illustrates a hammer drill, in some embodiments, the components described herein are incorporated into other types of power tools including drill-drivers, impact drivers, impact wrenches, angle grinders, circular saws, reciprocating saws, string trimmers, leaf blowers, vacuums, and the like.

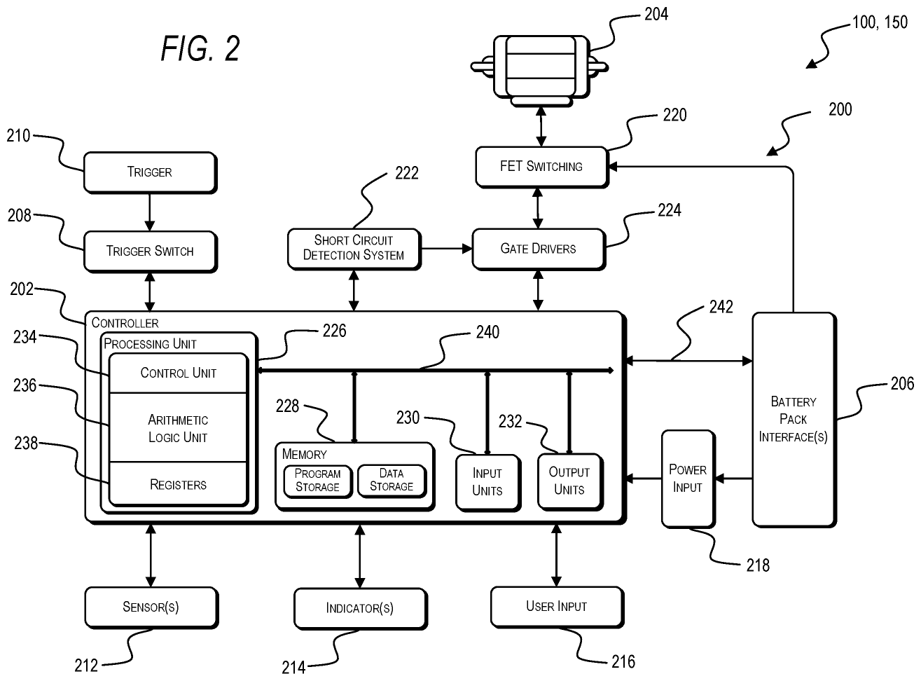

FIG. 2 illustrates a control system 200 for the power tool 100, 150 that includes a short circuit detection system. The control system 200 includes a controller 202. The controller 202 is electrically and/or communicatively connected to a variety of modules or components of the power tool 100, 150. For example, the illustrated controller 202 is electrically connected to a motor 204, a battery pack interface 206, a trigger switch 208 (connected to a trigger 210), one or more sensors or 212 (also referred to as sensing circuits), one or more indicators 214, a user input module 216, a power input module 218, an inverter or a FET switching module 220 (e.g., including a plurality of switching FETs), and gate drivers 224 for driving the FET switching module 220. The controller 202 includes combinations of hardware and software that are operable to, among other things, control the operation of the power tool 100, 150, monitor the operation of the power tool 100, 150, activate the one or more indicators 214 (e.g., an LED), etc. A short circuit detection system or circuit 222 is connected to the controller 202 and the gate drivers 224. In some embodiments, the sensors 212 measure or detect a current in the inverter or FET switching module 220) (e.g., a current of one or more phases of the inverter).

The controller 202 includes a plurality of electrical and electronic components that provide power, operational control, and protection to the components and modules within the controller 202 and/or the power tool 100, 150. For example, the controller 202 includes, among other things, a processing unit 226 (e.g., a microprocessor, a microcontroller, an electronic controller, an electronic processor, or another suitable programmable device), a memory 228, input units 230), and output units 232. The processing unit 226 includes, among other things, a control unit 234, an arithmetic logic unit (“ALU”) 236, and a plurality of registers 238, and is implemented using a known computer architecture (e.g., a modified Harvard architecture, a von Neumann architecture, etc.). The processing unit 226, the memory 228, the input units 230, and the output units 232, as well as the various modules or circuits connected to the controller 202 are connected by one or more control and/or data buses (e.g., common bus 240). The control and/or data buses are shown generally in FIG. 2 for illustrative purposes. The use of one or more control and/or data buses for the interconnection between and communication among the various modules, circuits, and components would be known to a person skilled in the art in view of the invention described herein.

The memory 228 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 226 is connected to the memory 228 and executes software instructions that are capable of being stored in a RAM of the memory 228 (e.g., during execution), a ROM of the memory 228 (e.g., on a generally permanent basis), or another non-transitory computer readable medium such as another memory or a disc. Software included in the implementation of the power tool 100, 150 can be stored in the memory 228 of the controller 400. The software includes, for example, firmware, one or more applications, program data, filters, rules, one or more program modules, and other executable instructions. The controller 202 is configured to retrieve from the memory 228 and execute, among other things, instructions related to the control processes and methods described herein. In other constructions, the controller 202 includes additional, fewer, or different components.

The battery pack interface 206 includes a combination of mechanical components (e.g., rails, grooves, latches, etc.) and electrical components (e.g., one or more terminals) configured to and operable for interfacing (e.g., mechanically, electrically, and communicatively connecting) with a battery pack. For example, power provided by the battery pack 164, 300 to the power tool 100, 150 is provided through the battery pack interface 206 to the power input module 218. The power input module 218 includes combinations of active and passive components to regulate or control the power received from the battery pack 164, 300 prior to power being provided to the controller 202. The battery pack interface 206 also supplies power to the FET switching module 220 to be switched by the switching FETs to selectively provide power to the motor 204. The battery pack interface 206 also includes, for example, a communication line 242 for provided a communication line or link between the controller 202 and the battery pack 164, 300. In some embodiments, the controller 202 is also electrically and/or communicatively connected to the short circuit detection circuit 222 via a signal line.

The sensors 212 include one or more current sensors, one or more speed sensors, one or more Hall Effect sensors, one or more temperature sensors, etc. The indicators 214 include, for example, one or more light-emitting diodes (“LEDs”). The indicators 214 can be configured to display conditions of, or information associated with, the power tool 100, 150. For example, the indicators 214 are configured to indicate measured electrical characteristics of the power tool 100, 150, the status of the power tool, the status of the circuit 222, etc. The user input module 216 is operably coupled to the controller 202 to, for example, select a forward mode of operation or a reverse mode of operation, a torque and/or speed setting for the power tool 100, 150 (e.g., using torque and/or speed switches), etc. In some embodiments, the user input module 216 includes a combination of digital and analog input or output devices required to achieve a desired level of operation for the power tool 100, 150, such as one or more knobs, one or more dials, one or more switches, one or more buttons, etc.

The circuit 222 is configured to monitor one or more electrical characteristics of the power tool 100, 150 for conditions that indicate a short circuit fault condition. In some embodiments, for example, the circuit 222 monitors one or more electrical characteristics of the plurality of switching FETs of the FET switching module 220 for conditions indicating shoot-though. In some embodiments, for example, the circuit 222 monitors one or more electrical characteristics of motor 204 for conditions indicating a locked rotor. In some embodiments, when the circuit 222 determines that one or more electrical characteristics indicate a short circuit fault condition, the circuit 222 commands the gate drivers 224 to prevent the FET switching module 220 from providing power to the motor 204. In some embodiments, circuit 222 determines that one or more electrical characteristics indicate an unwanted current, an uncontrolled current, a damaging current, a hazardous current, and the like.

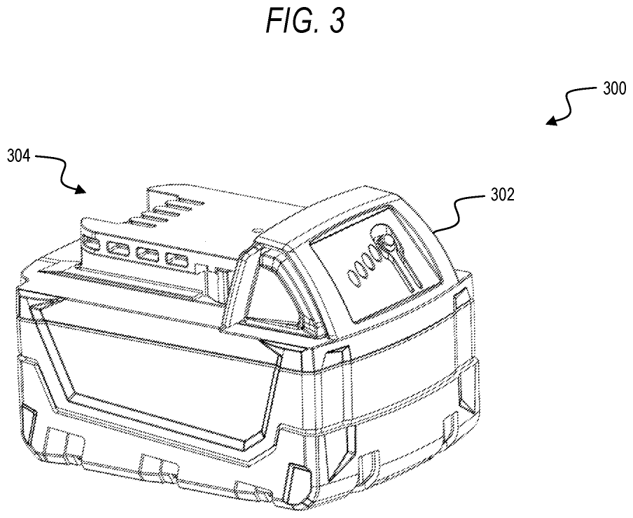

FIG. 3 illustrates a battery pack 300. The battery pack 300 includes a housing 302 and an interface portion 304 for connecting the battery pack 300 to a power tool, such as the power tool 100, 150. In some embodiments, the battery pack 300 has a nominal voltage rating of 18 Volts.

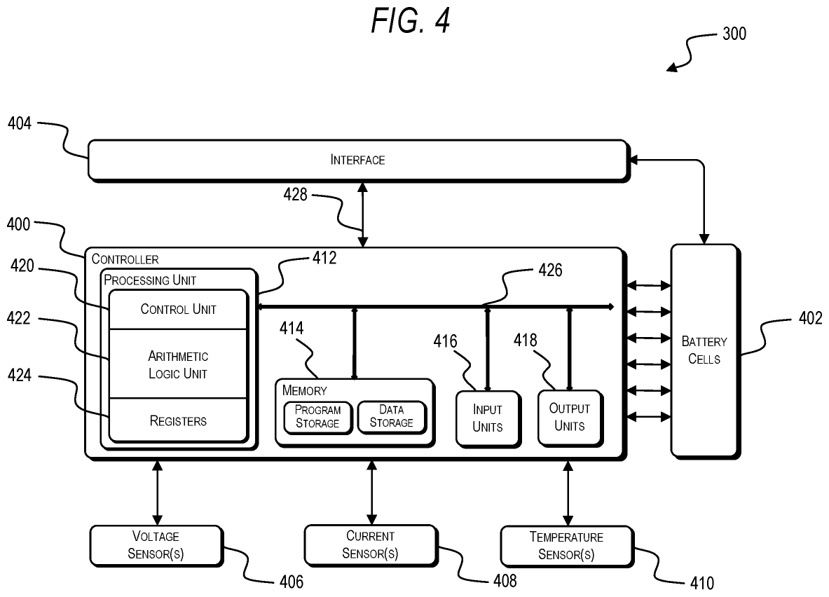

FIG. 4 illustrates a control system for the battery pack 300. The control system includes a controller 400. The controller 400 is electrically and/or communicatively connected to a variety of modules or components of the battery pack 300. For example, the illustrated controller 400 is connected to one or more battery cells 402 and an interface 404 (e.g., the interface portion 304 of the battery pack 300 illustrated in FIG. 3). The controller 400 is also connected to one or more voltage sensors or voltage sensing circuits 406, one or more current sensors or current sensing circuits 408, and one or more temperature sensors or temperature sensing circuits 410. The controller 400 includes combinations of hardware and software that are operable to, among other things, control the operation of the battery pack 300, monitor a condition of the battery pack 300, enable or disable charging of the battery pack 300, enable or disable discharging of the battery pack 300, etc.

The controller 400 includes a plurality of electrical and electronic components that provide power, operational control, and protection to the components and modules within the controller 400 and/or the battery pack 300. For example, the controller 400 includes, among other things, a processing unit 412 (e.g., a microprocessor, a microcontroller, an electronic processor, an electronic controller, or another suitable programmable device), a memory 414, input units 416, and output units 418. The processing unit 412 includes, among other things, a control unit 420, an ALU 422, and a plurality of registers 424, and is implemented using a known computer architecture (e.g., a modified Harvard architecture, a von Neumann architecture, etc.). The processing unit 412, the memory 414, the input units 416, and the output units 418, as well as the various modules or circuits connected to the controller 400 are connected by one or more control and/or data buses (e.g., common bus 426). The control and/or data buses are shown generally in FIG. 4 for illustrative purposes. The use of one or more control and/or data buses for the interconnection between and communication among the various modules, circuits, and components would be known to a person skilled in the art in view of the invention described herein.

The memory 414 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 412 is connected to the memory 414 and executes software instructions that are capable of being stored in a RAM of the memory 414 (e.g., during execution), a ROM of the memory 414 (e.g., on a generally permanent basis), or another non-transitory computer readable medium such as another memory or a disc. Software included in the implementation of the battery pack 300 can be stored in the memory 414 of the controller 400. The software includes, for example, firmware, one or more applications, program data, filters, rules, one or more program modules, and other executable instructions. The controller 400 is configured to retrieve from the memory 414 and execute, among other things, instructions related to the control processes and methods described herein. In other constructions, the controller 400 includes additional, fewer, or different components.

The interface 404 includes a combination of mechanical components (e.g., rails, grooves, latches, etc.) and electrical components (e.g., one or more terminals) configured to and operable for interfacing (e.g., mechanically, electrically, and communicatively connecting) the battery pack 300 with another device (e.g., a power tool, a battery pack charger, etc.). For example, the interface 404 is configured to communicatively connect to the controller 400 via a communications line 428.

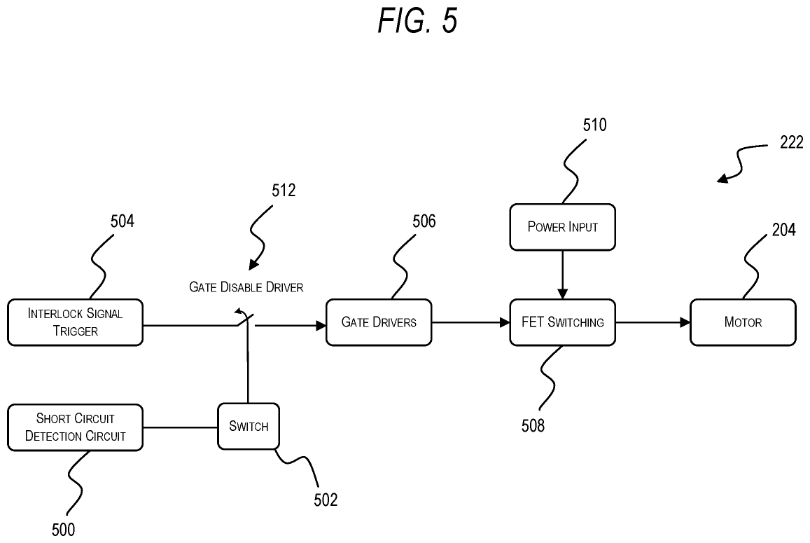

FIG. 5 illustrates the short circuit detection system or circuit 222. The circuit 222 is configured to determine whether one or more fault conditions of the power tool 100, 150 is present and generate one or more control signals related to the presence of one or more fault conditions. For example, the circuit 222 is configured to detect an undervoltage condition of the one or more battery cells 402 or battery packs 300, and an over current condition (e.g., shoot-through, locked rotor) of the motor 204. The circuit 222 includes a short circuit detection circuit 500 electrically coupled with a switch 502. An interlock signal trigger 504 provides an electrical signal to the gate drivers 506, which control the FET switching module 508 (e.g. including a plurality of switching FETs). A power input 510, such as a power input provided by the battery pack 300, is electrically coupled with the FET switching module 508. In some embodiments, the interlock signal trigger 504 commands the gate drivers 506 to drive the FET switching module 508 to allow current to flow from the power input 510 to the motor 204.

If the circuit 222 detects one or more fault conditions of the power tool 100, 150, the circuit 222 disables operation of the device. For example, when the short circuit detection circuit 500 detects a fault condition, the short circuit detection circuit opens switch 502, triggering a gate disable driver 512. The gate disable driver 512 interrupts the interlock signal trigger 504 and prevents the gate drivers 506 from driving the motor 204. In some embodiments, the one or more fault conditions are an unwanted current, an uncontrolled current, a damaging current, a hazardous current, and the like. In some embodiments, the circuit disables the device for a predetermined period of time. In some embodiments, the switch 502 is latched active and is unlatched to open the switch 502 (e.g., to disable the gate driver 506).

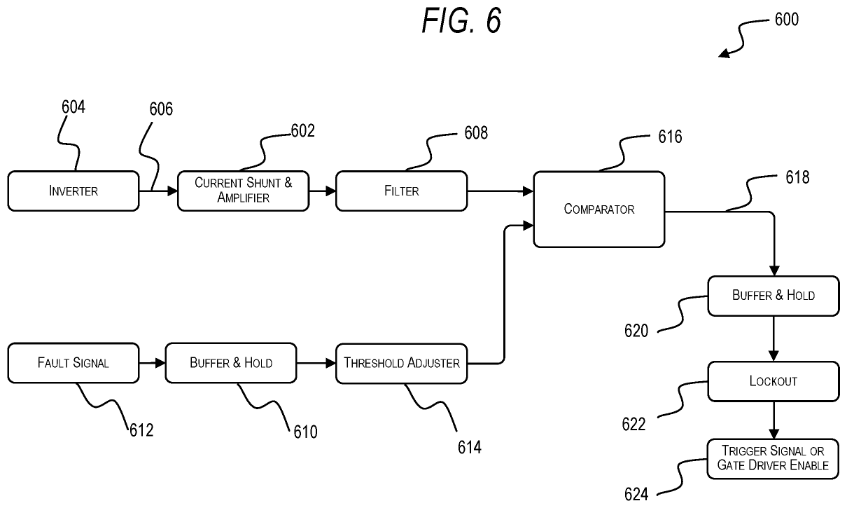

FIG. 6 illustrates an exemplary embodiment of the short circuit detection system 222 as short circuit detection system or circuit 600. The illustrated circuit 600 does not require firmware (e.g., the circuit 600 can operate independently of the controller 202). The circuit 600 includes a current shunt and amplifier 602 which is configured to receive an electrical signal. In some embodiments, the electrical signal is a back electromotive force signal. In some embodiments, the electrical signal is a current sense signal associated with a current through the motor 204. In an exemplary embodiment, the current shunt and amplifier 602 is coupled (e.g. electrically, communicatively) with inverter 604 and receives an electrical signal, such as an inverter signal 606, from inverter 604 and amplifies the inverter signal for determining a current measurement. In some embodiments, inverter 604 includes a plurality of inverter phases, and short circuit detection system or circuit 222 is configured to monitor the plurality of inverter phases. In some embodiments, short circuit detection system or circuit 222 is configured to monitor one of the plurality of inverter phases. In some embodiments, the short circuit detection system or circuit 222 is configured to monitor more than one of the plurality of inverter phases. In some embodiments, circuit 222 is configured to monitor a current coming from a battery pack, a current returning to a battery pack, or both the currents coming from and returning to a battery. Filter 608 filters the current measurement of the inverter signal 606 to have, for example, a fast rise and slow decay time (e.g., hysteresis). Additionally, the circuit 600 includes a first buffer and hold stage 610 for receiving a fault signal 612. In some embodiments, the fault signal 612 is a digital fault signal from the gate driver 224 or FET switching module 220. The fault signal is indicative of, for example, a short circuit condition of the motor 204. The first buffer and hold stage 610 provides electrical impedance between the fault signal 612 and a threshold adjustor 614. A fault condition persistence (e.g., fault active duration) can be set as, for example a time delay in the first buffer and hold stage 610 or using a latch. In some embodiments, the threshold adjustor 614 shifts an overcurrent threshold in response to the fault signal 612. In some embodiments, the threshold adjustor 614 shifts the overcurrent threshold for a configurable amount of time (e.g. 1 ms, 1 s, etc.). In some embodiments, the threshold adjustor 614 shifts the overcurrent threshold for a configurable amplitude (e.g. 1 mA, 1 A, etc.). By shifting the overcurrent threshold, a short circuit can be more reliably detected, and the short circuit can be distinguished from other high-current conditions the power tool 100, 150 may encounter.

The circuit 600 includes a comparator 616. In some embodiments, comparator 616 is an operational amplifier. In some embodiments, comparator 616 is a differential amplifier. Comparator 616 is coupled (e.g. electrically, communicatively) with the threshold adjustor 614 and the filter 608. The comparator 616 is configured to compare the current measurement of the inverter signal 606 to the overcurrent threshold. If, for example, comparator 616 determines that the electrical signal has exceeded the overcurrent threshold set by the threshold adjustor 614, the comparator 616 generates a fault condition signal 618 and outputs the fault condition signal 618 to a second buffer and hold stage 620. In some embodiments, the second buffer and hold stage 620 provides electrical impedance between the comparator 616 and a lockout stage 622. In some embodiments, the lockout stage 622 prevents the gate drivers 506 from driving the motor 204. In some embodiments, the lockout stage 622 disables a trigger signal. Following lockout stage 622, the gate drivers 506 and/or the trigger signal can be re-enabled at a re-enable stage 624 (e.g., after the short circuit condition has ended), and the power tool can again be operated normally. In some embodiments, the circuit 600 provides a non-functional signal to the controller 202 to notify the controller 202 that the fault condition is active. In some embodiments, the fault conditions are one or more of an unwanted current, an uncontrolled current, a damaging current, a hazardous current, and the like.

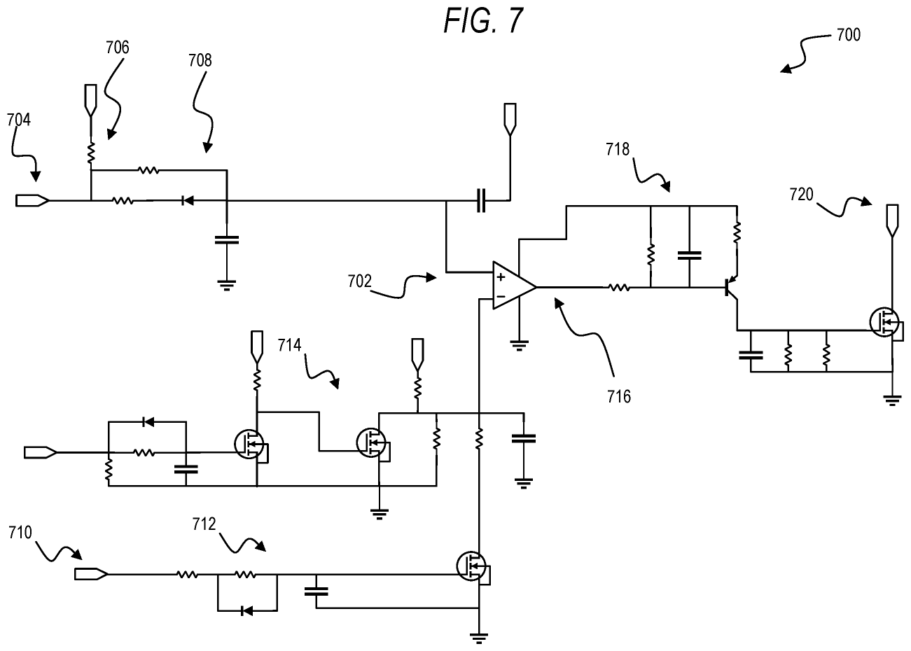

FIG. 7 illustrates an exemplary embodiment of the short circuit detection system or circuit 222, 600. The circuit 222, 600 includes circuitry 700. In the illustrated exemplary embodiment of the circuit 222, 600, the circuitry 700 includes a comparator 702. In some embodiments, the comparator 702 performs functions similar to the comparator 616. The circuitry 700 includes an electrical signal input, such as inverter signal 704. The circuitry 700 includes a current shunt 706 along with filter 708. In some embodiments, current shunt 706 and filter 708 perform functions similar to current shunt and amplifier 602 and filter 608, respectively. For example, current shunt 706 provides a current measurement of the inverter signal 704, and filter 708 provides filtering of the inverter signal 704. In some embodiments, filter 708 is a low pass filter configured to bias the inverter signal 704 to have, for example, a fast rise and slow decay time. Circuitry 700 includes a fault signal 710. In some embodiments, fault signal 710 is a digital signal. Circuitry 700 includes a first buffer and hold stage 712 for receiving a fault signal 710. The first buffer and hold stage 712 provides electrical impedance between the fault signal 710 and a threshold adjustor 714. In some embodiments, threshold adjustor 714 performs functions similar to threshold adjustor 614. In some embodiments, the threshold adjustor 714 shifts an overcurrent threshold in response to the fault signal 710. In some embodiments, the threshold adjustor 714 shifts the overcurrent threshold for a configurable amount of time (e.g. 1 ms, 1 s, etc.). In some embodiments, the threshold adjustor 714 shifts the overcurrent threshold for a configurable amplitude (e.g. 1 mA, 1 A, etc.).

In some embodiments of the circuitry 700 of the circuit 222, 600, the comparator 702 is an operational amplifier. In some embodiments, comparator 616 is a differential amplifier. Comparator 702 is coupled (e.g. electrically, communicatively) with the threshold adjustor 714 and the filter 708 and is configured to compare the current measurement of the inverter signal 704 to the overcurrent threshold. If, for example, comparator 702 determines that the electrical signal has exceeded the overcurrent threshold set by the threshold adjustor 714, the comparator 702 generates a fault condition signal 716. The comparator 702 outputs the fault condition signal 716 to a second buffer and hold stage 718. In some embodiments, the second buffer and hold stage 718 provides electrical impedance between the comparator 702 and a lockout stage 720. In some embodiments, the lockout stage 720 prevents the gate drivers 506 from driving the motor 204. In some embodiments, the lockout stage 720 disables a trigger signal.

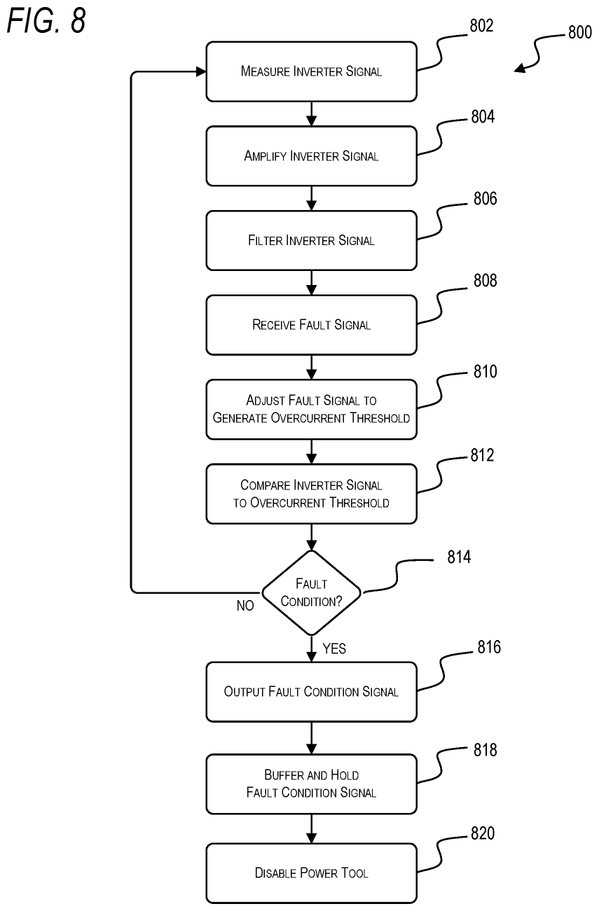

FIG. 8 illustrates a process 800 of detecting a short circuit in a power tool. In some embodiments, process 800 is implemented by circuit 600. In some embodiments, process 800 is implemented by the circuitry 700 of the circuit 600. The process 800 begins at STEP 802 by measuring an electrical signal of the power tool 100, 150, such as inverter signal 606, 704. In some embodiments, the measured electrical signal of the power tool corresponds with one of the plurality of inverter phases. In some embodiments, short circuit detection system is configured to monitor a current coming from a battery pack, a current returning from a battery pack, or both the currents coming from and returning to a battery pack. The process 800 then proceeds to STEP 804, where the inverter signal 606, 704 is amplified, for example, by the amplifier 602. The process 800 then proceeds to STEP 806, where the inverter signal 606, 704 is filtered, for example, by filter 608, 708. The process 800 then proceeds to STEP 808 where a fault signal, such as fault signal 612, 710, is received by a buffer, such as first buffer and hold stage 610, 712. The process 800 then proceeds to STEP 810 where the fault signal is adjusted, such as by threshold adjustor 614, 714, to generate the overcurrent threshold. The process 800 then proceeds to STEP 812, where a comparator, such as comparator 616, 702, compares a signal, such as inverter signal 606, 704 to the overcurrent threshold generated in STEP 810. If, at STEP 814, the measured electrical signal is not indicative of a fault condition, for example, if the inverter signal 606, 704 does not exceed overcurrent threshold, the process 800 proceeds to STEP 802. If, at STEP 814, the measured electrical signal is indicative of a fault condition, for example, if the inverter signal 606, 704 exceeds the overcurrent threshold, the process 800 proceeds to STEP 816 where a fault condition is output, for example, by comparator 616, 702. The process 800 then proceeds to STEP 818, where a fault condition signal is buffered, for example by second buffer and hold stage 620, 718. The process 800 then proceeds to STEP 820, where the short circuit detection system 600 disables the power tool 100, 150. In some embodiment, short circuit detection system 600 disables the power tool 100, 150 by preventing the gate drivers 506 from driving the motor 204. In some embodiments, the short circuit detection system 600 disables the power tool 100, 150 disables a trigger signal.

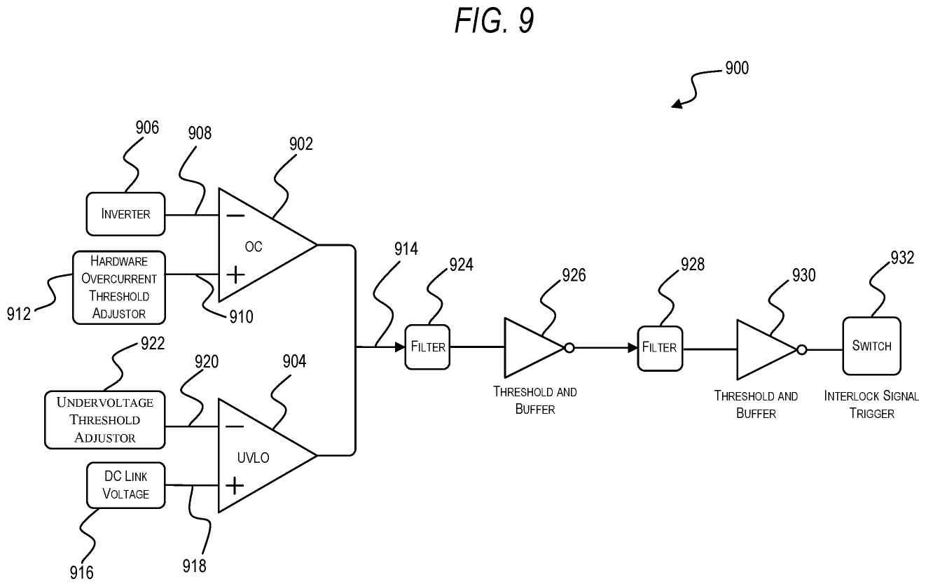

FIG. 9 illustrates an exemplary embodiment of a short circuit detection system or circuit 900. The illustrated circuit 900 does not require firmware (e.g., the circuit 900 can operate independently of the controller 202). The circuit 900 includes a first comparator 902. In some embodiments, the comparator 902 is an overcurrent comparator. The circuit 900 also includes a second comparator 904. In some embodiments, the comparator 904 is an undervoltage comparator. In other embodiments, different signals are used, such as a back electromotive force, Hall effect sensors, sensed three-phase current, etc., can be used to detect a short circuit. In some embodiments, the comparators 902, 904 are operational amplifiers. In some embodiments, comparator 902, 904 are differential amplifiers. In some embodiments, comparators 902, 904 are a combination of differential, operational, and/or any other type of suitable amplifier. In an exemplary embodiment, the first comparator 902 is coupled (e.g. electrically, communicatively) to the inverter 906, and receives an electrical signal, such as an inverter signal 908, from inverter 906. In some embodiments, the inverter 906 includes a plurality of inverter phases, and short circuit detection system or circuit 900 is configured to monitor the plurality of inverter phases. In some embodiments, short circuit detection system or circuit 900 is configured to monitor one of the plurality of inverter phases. In some embodiments, the short circuit detection system or circuit 900 is configured to monitor more than one of the plurality of inverter phases. In some embodiments, circuit 900 is configured to monitor a current from to a battery pack, a current returning to a battery pack, or both the currents coming from and returning to a battery pack. The comparator 902 is configured to receive a first fault threshold or an overcurrent threshold 910 from a hardware overcurrent threshold adjustor 912 (also referred to as threshold adjuster or overcurrent threshold adjustor). The comparator 902 is configured to compare the current measurement of the inverter signal 908 to the overcurrent threshold 910. If, for example, comparator 902 determines that the electrical signal has exceeded the overcurrent threshold set by the threshold adjustor 912, the comparator 902 generates a fault condition signal 914 and outputs the fault condition signal 914. In some embodiments, comparator 902 may determine that the electrical signal is indicative of one or more fault conditions, such as an unwanted current, an uncontrolled current, a damaging current, a hazardous current, and the like.

In an exemplary embodiment, the second comparator 904 is coupled (e.g. electrically, communicatively) with DC link voltage 916 and receives an electrical signal, such as a voltage measurement 918, from the DC link voltage 916. The comparator 904 is configured to receive a second fault threshold or an undervoltage threshold 920 from a undervoltage threshold adjustor 922. The comparator 904 is configured to compare the voltage measurement 918 to the undervoltage threshold 920. If, for example, comparator 904 determines that the electrical signal is less than or equal to the undervoltage threshold set by the undervoltage threshold adjustor 922, the comparator 904 generates a fault condition signal 914 and outputs the fault condition signal 914.

When a fault condition has been generated by either comparator 902 or comparator 904, or a combination of comparators 902, 904 (i.e., and OR logic configuration), the fault condition signal 914 is output to a first filter 924. In some embodiments, filter 924 is a low pass filter. The fault condition signal 914 is then sent to a first threshold and buffer stage 926. In some embodiments, threshold and buffer stage 926 adjusts the fault condition signal 914 and provides a high input electrical impedance for the output of the comparator 902 and comparator 904. The first threshold and buffer stage 926 then sends the fault condition signal 914 to a second filter 928. A fault condition persistence (e.g., fault active duration) can be set as, for example a time delay in the first threshold and buffer stage 926 or using a latch. In some embodiments, filter 928 is a low pass filter. The fault condition signal 914 is then sent to a second threshold and buffer stage 930. In some embodiments, the first buffer 926 delays the fault condition signal 914 by a configurable amount of time (e.g. 0 s, 1 ms, 1 s, etc.). In some embodiments, the second buffer 930 also delays the fault condition signal 914 by a configurable amount of time. The fault condition signal 914 is then provided to a switch 932. In some embodiments, switch 932 is coupled (e.g. electrically, communicatively) to the gate drivers 224, 506. In some embodiments, switch 932 controls the interlock signal trigger 504, which provides an electrical signal to the gate drivers 224, 506 to control the FET switching module 220, 508 (e.g. including a plurality of switching FETs). In some embodiments, switch 932 is configured to prevent the gate drivers 224, 506 from controlling the FET switching module 508, thereby disabling the power tool 100, 150. In some embodiments, the circuit 900 provides a non-functional signal to the controller 202 to notify the controller 202 that the fault condition is active.

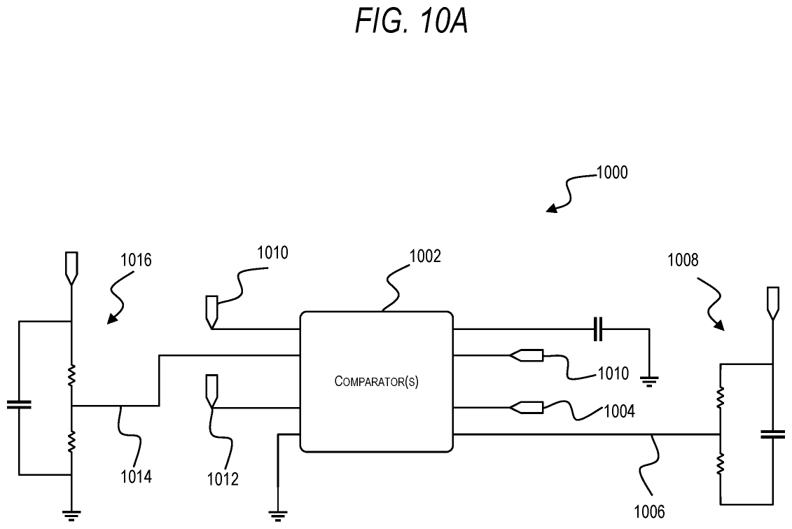

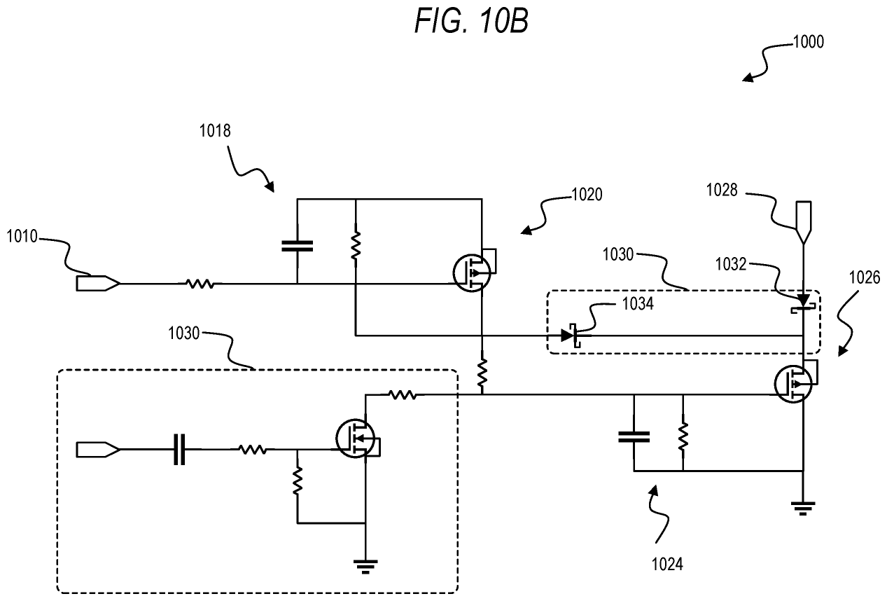

FIGS. 10A and 10B illustrate an exemplary embodiment of the short circuit detection system or circuit 222, 900. The circuit 222, 900 includes circuitry 1000. FIG. 10A illustrates a part of an embodiment of circuitry 1000, including one or more comparators 1002. In some embodiments, comparators 1002 perform functions similar to comparator 902 and comparator 904. Comparators 1002 are configured to receive a first electrical signal, such as a current measurement 1004 of an inverter signal. In some embodiments, the current measurement 1004 of the inverter signal 908 is similar to the current measurements. The comparators 1002 are configured to receive an overcurrent threshold 1006 from an overcurrent threshold adjuster 1008. In some embodiments, the overcurrent threshold 1006 is similar to the overcurrent threshold 910, and an overcurrent threshold adjustor 1008 is similar to the overcurrent threshold adjustor 912. The comparators 1002 are configured to compare the current measurement 1004 to the overcurrent threshold 1006 to determine if a fault condition has occurred. If, for example, comparators 1002 determine that the current measurement 1004 is greater than or equal to the overcurrent threshold set by the threshold adjustor 1008, the comparators 1002 generate a fault condition signal 1010, and output the fault condition signal 1010. In some embodiments, comparators 1002 are configured to receive a second electrical signal, such as a voltage measurement 1012. In some embodiments, the voltage measurement 1012 is similar to the voltage measurement 918. The comparators 1002 are configured to receive an undervoltage threshold 1014 from an undervoltage threshold adjuster 1016. In some embodiments, the undervoltage threshold 1014 is similar to the undervoltage threshold 920, and the overcurrent threshold adjustor 1008 is similar to the overcurrent threshold adjustor 912. The comparators 1002 are configured to compare the voltage measurement 1012 to the undervoltage threshold 1014 to determine if a fault condition has occurred. If, for example, comparators 1002 determine that the voltage measurement 1012 is greater than or equal to the undervoltage threshold 1014 set by the threshold adjustor 1016, the comparators 1002 generate a fault condition signal 1010 and outputs the fault condition signal 1010.

FIG. 10B illustrates another part of the circuitry 1000. Fault condition signal 1010 is provided from the comparators 1002 to a first filter 1018. In some embodiments, the filter 1018 is similar to the filter 924. Fault condition signal 1010 is then provided to a first threshold and buffer stage 1020. In some embodiments, the first threshold and buffer stage 1020 is similar to the threshold and buffer stage 926. The fault condition signal 1010 then passes through a second filter stage 1024. In some embodiments, the second filter 1024 is similar to the filter 928. In some embodiments, greater or fewer filters are included. In some embodiments, greater or fewer threshold and buffer stages, such as threshold and buffer stage 1020, 1022 are included. The fault condition signal 1010 is then provided to a second threshold and buffer stage 1026. In some embodiments, the second threshold and buffer stage 1026 is similar to the threshold and buffer stage 930. The second threshold and buffer stage 1026 outputs a disable signal 1028. In some embodiments, disable signal 1028 is configured to prevent gate drivers 224, 506 from controlling the FET switching module 220, 508, thereby disabling the power tool 100, 150. In some embodiments, a latch circuit 1030 is provided to prevent the disable signal 1028 from being improperly output. The latch circuit includes diodes 1032, 1034 (e.g., Zener diodes).

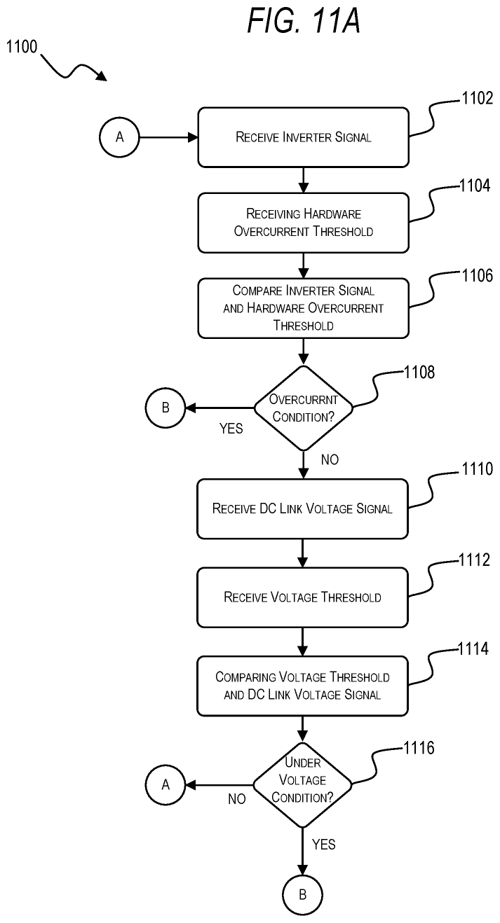

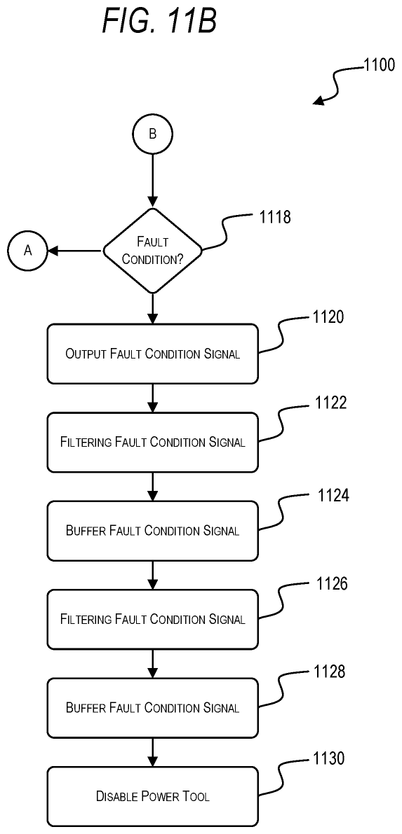

FIGS. 11A and 11B illustrate a process 1100 of detecting a short circuit in a power tool. In some embodiments, process 1100 is implemented by short circuit detection system 900. In some embodiments, process 1100 is implemented by the circuitry 1000 of the short circuit detection system 900. FIG. 11A illustrates a part of the process 1100, and begins at STEP 1102. At STEP 1102, the comparators 902, 1002 receive an electrical signal of the power tool 100, 150, such as a current measurement of an inverter signal. In some embodiments, the measured electrical signal of the power tool corresponds to one or more of the plurality of inverter phases. In some embodiments, the short circuit detection system is configured to monitor a current coming from a battery pack, a current returning to a battery pack, or both the currents coming from and returning to a battery pack. The process 1100 then proceeds to STEP 1104, by receiving, by the comparators 902, 1002, the overcurrent threshold 910, 1006. The process 1100 then proceeds to STEP 1106, where the comparators compare the current measurement to the overcurrent threshold of STEP 1104. If, at STEP 1108, the measured electrical signal is indicative of a fault condition, for example, if current measurement exceeds the overcurrent threshold, the process 1100 proceeds to STEP 1118 (see FIG. 11B).

If, at STEP 1108, the current measurement is not indicative of a fault condition, the process 1100 proceeds to STEP 1110. Process 1100 continues with STEP 1110 by receiving, by the comparators 904, 1002 the voltage measurement 918, 1012. The process 1100 then proceeds to STEP 1112, by receiving, by the comparators 904, 1002, a voltage threshold, such as the undervoltage threshold 920, 1014. The process 1100 then proceeds to STEP 1114, where the comparators 904, 1002 compare the voltage measurement 918, 1012, to the undervoltage threshold. If, at STEP 1116, the voltage measurement 918, 1012 is not indicative of a fault condition, the process 1100 returns to STEP 1102. If, at STEP 1116, the voltage measurement 918, 1012 is indicative of a fault condition, the process 1100 proceeds to STEP 1118 (see FIG. 11B).

FIG. 11B illustrates another part of process 1100, and continues with STEP 1118 where the comparators 902, 904, 1002 determine that a fault condition has occurred. If, at STEP 1118, the comparators 902, 904, 1002 determine that a fault condition has not occurred, process 1100 returns to STEP 1102. If the comparators 902, 904, 1002 determine that a fault condition has occurred, such as overcurrent condition or undervoltage condition, the comparators 902, 904, 1002 generate the fault condition signal 914, 1010. The process 1100 then proceeds to STEP 1120, where the comparators 902, 904, 1002 output the fault condition signal 914, 1010 to the filter 924, 1018. The process 1100 then proceeds to STEP 1122, where the filter 924, 1018 receives the fault condition signal 914, 1010 and filters the fault condition signal 914, 1010. The process 1100 then proceeds to STEP 1124, where the buffer 926, 1020 buffers the fault condition signal 914, 1010. The process 1100 then proceeds to STEP 1126, where the filter 928, 1024, filters the fault condition signal 914, 1010. The process 1100 then proceeds to STEP 1128, where the buffer 930, 1022, buffers the fault condition signal 914, 1010. The process 1100 then proceeds to STEP 1130, where the switch 932 disables the power tool 100, 150. In some embodiments, the short circuit detection system 900 disables the power tool 100, 150 by disabling a trigger signal. In some embodiments, the short circuit detection system 900 disables the power tool 100, 150 by preventing the gate drivers 506 from driving the motor 204.

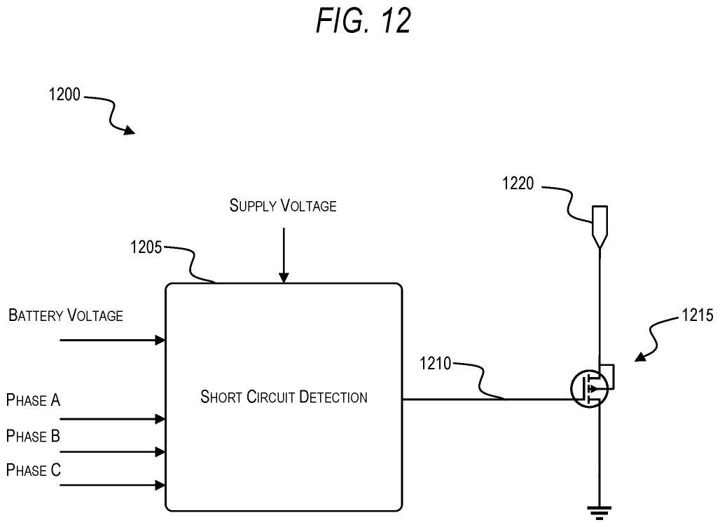

FIG. 12 illustrates another embodiment of a short circuit detection circuit 1200. The short circuit detection circuit 1200 includes a programmable integrated circuit 1205 that is configured to monitor for a short circuit condition of the power tool 100, 150. The circuit 1205 (e.g., short circuit detection system 222) is powered by a supply voltage (e.g., 3.3V, 5V, etc.) The circuit 1205 receives an input voltage signal related to a battery pack voltage. In some embodiments, the input voltage signal corresponds to the voltage of the battery pack. In other embodiments, the input voltage signal corresponds to a DC link bus voltage (e.g., system bus voltage) that may have a value that differs from the battery pack voltage. The circuit 1205 also receives one or more input current signals (e.g., Phase A, Phase B, Phase C, etc.). The one or more input current signals correspond to current through the inverter or FET switching module 220 and motor 204. If multi-phase current is being provided to the motor 204, current sensors can be used to detect the current in each phase. If the circuit 1205 detects a short circuit condition, the circuit 1205 provides an output 1210 to a switch 1215 to disable the motor 204 (e.g., disable a gate driver that drives the switch 1215). Although only one switch is illustrated, a plurality of switches (e.g., in the inverter or FET switching module 220 are similarly controlled to disable the motor 204. Power 1220 from the battery pack is then prevented from driving the motor 204.

The circuit 1205 is programmed to include a plurality of different short circuit overcurrent thresholds. In some embodiments, a particular short circuit overcurrent threshold is preselected for a particular power tool application (e.g., based on platform voltage). In some embodiments, the circuit 1205 is configured to dynamically adjust the short circuit overcurrent threshold based on a voltage associated with the power tool, such as a battery pack voltage or a DC link bus voltage. The higher the voltage value, the higher the short circuit overcurrent threshold can be set. For example, larger battery packs including higher voltages and capacities can have lower direct current internal resistances than other battery packs. The short circuit overcurrent threshold can be increased for such battery packs that are capable of outputting higher currents.

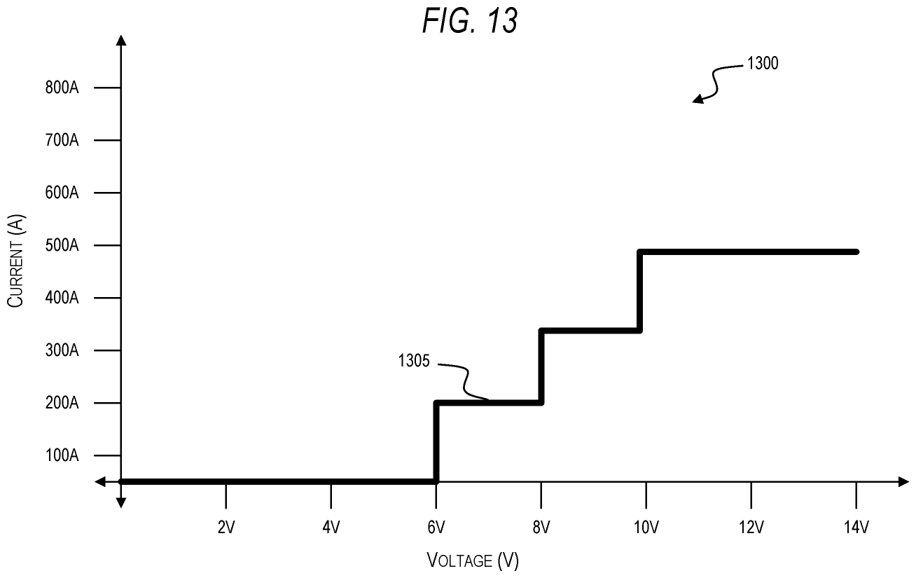

FIG. 13 illustrates a graph 1300 of the short circuit overcurrent threshold according to some embodiments. The values illustrated in FIG. 13 are merely exemplary and provided for descriptive purposes. Different threshold values could be used for different power tool applications. As the voltage related to the battery pack or DC link voltage increases, the short circuit overcurrent threshold 1305 also increases. In some embodiments, the short circuit overcurrent threshold 1305 is based on a voltage of one or more battery packs connected to the power tool 100, 150. The short circuit overcurrent threshold 1305 can be modified as the one or more battery packs become depleted. In other embodiments, the short circuit overcurrent threshold 1305 is based on a DC link bus voltage (e.g., where multiple battery packs may be attached to the power tool 100, 150). The area under the short circuit overcurrent threshold 1305 corresponds to the operating range of the power tool 100, 150. In some embodiments, rather than the short circuit overcurrent threshold being only a current value that is used to disable a motor when exceeded, a temporal aspect of the short circuit overcurrent threshold can be implemented. For example, the short circuit overcurrent threshold need to be exceeded for a period of time before the motor is disabled. By incorporating time as a condition for disabling the motor, different time thresholds can be set. For example, relatively higher current values can be permitted for smaller periods of time, and relatively lower current values can be permitted for longer periods of time. Configuring the short circuit overcurrent thresholds in such a way provides greater flexibility to extract as much power from the battery pack(s) as possible.

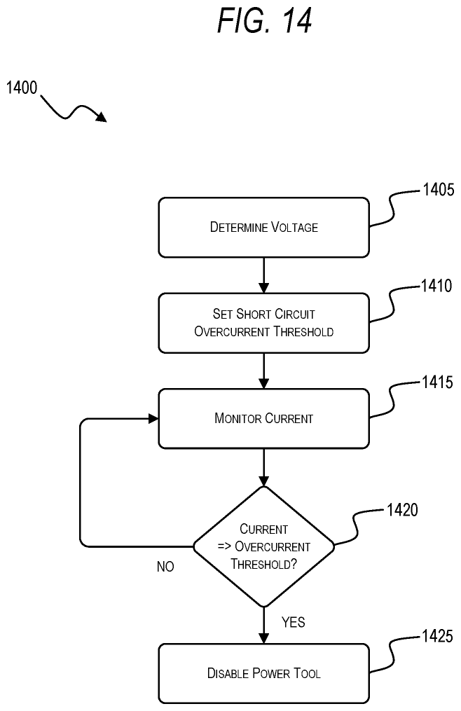

FIG. 14 illustrates a process 1400 for controlling the power tool 100, 150. At STEP 1405, the circuit 1205 determines a voltage related to the battery pack(s) for the power tool 100, 150. As described above, the voltage can be a voltage of one or more battery packs or a DC link bus voltage. Based on the determined voltage, the circuit 1205 determines or selects a short circuit overcurrent threshold (STEP 1410). The circuit 1205 then monitors the current through the inverter or FET switching module 220 and motor 204 (STEP 1415). In some embodiments, the current is monitored by one or more current sensors (e.g., shunt resistors) that detect the current through the motor 204. The circuit 1205 compares the measured current to the short circuit overcurrent threshold (STEP 1420). If the measured current is not greater than or equal to the short circuit overcurrent threshold, the process 1400 returns to STEP 1415 where current is continually monitored. If, at STEP 1420, the measured current is greater than the short circuit overcurrent threshold, the power tool 100, 150 is disabled (STEP 1425). The power tool 100, 150 is disabled by controlling a gate driver for a switch to disable the switch (e.g., in the FET switching module 220) and thereby prevent current from passing to the motor 204.

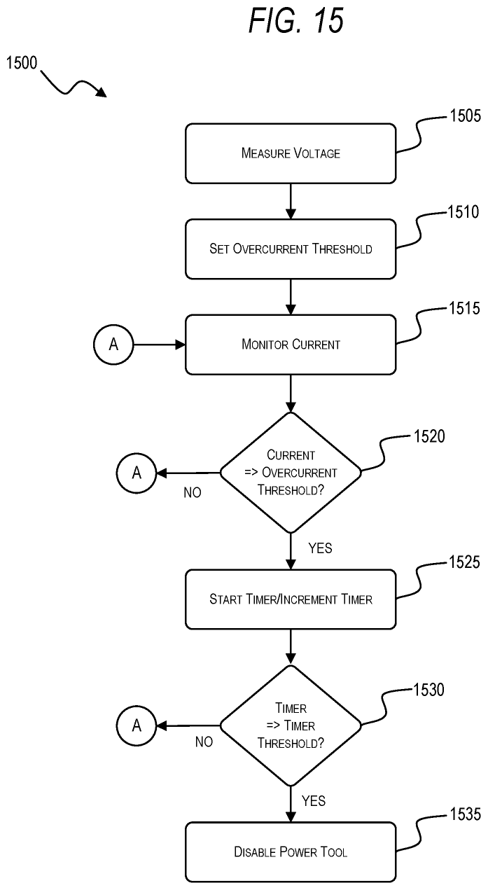

FIG. 15 illustrates a process 1500 for controlling the power tool 100, 150. At STEP 1505, the circuit 1205 determines a voltage related to the battery pack(s) for the power tool 100, 150. As described above, the voltage can be a voltage of one or more battery packs or a DC link bus voltage. Based on the determined voltage, the circuit 1205 determines or selects a short circuit overcurrent threshold (STEP 1510). The circuit 1205 then monitors the current through the inverter or FET switching module 220 and motor 204 (STEP 1515). In some embodiments, the current is monitored by one or more current sensors (e.g., shunt resistors) that detect the current through the motor 204. The circuit 1205 compares the measured current to the short circuit overcurrent threshold (STEP 1520). If the measured current is not greater than or equal to the short circuit overcurrent threshold, the process 1500 returns to STEP 1515 where current is continually monitored.

If, at STEP 1520, the measured current is greater than the short circuit overcurrent threshold, the circuit starts a timer or counter (STEP 1525). The timer or counter is implemented to determine whether the short circuit condition that may be present persists for a period of time (e.g., rather than merely being a transient current spike). In some embodiments, the circuit 1205 includes an internal clock (e.g., a real-time clock) that is used to keep track of time and a separate, dedicated timer or counter is not required. However, explanatory purposes, the timer is generally described as a way to keep track of elapsed time. If, at STEP 1530, the timer is equal to or greater than a timer threshold value (i.e., a prescribed amount of time has passed), the power tool 100, 150 is disabled (STEP 1535). The power tool 100, 150 is disabled by controlling a gate driver for a switch to disable the switch (e.g., in the FET switching module 220) and thereby prevent current from passing to the motor 204. If, at STEP 1530, the timer is less than the timer threshold, the process 1500 returns to STEP 1515 where current is continually monitored and STEP 1525 where the timer is incremented. If, before the timer reaches the timer threshold, the measured current falls back below the short circuit overcurrent threshold, the timer is stopped or reset and the power tool 100, 150 will continue to operate normally.

Thus, embodiments described herein provide short circuit mitigation for a power tool. Various features and advantages are set forth in the following claims.

1. A power tool comprising:
a housing;
a motor supported by the housing;
a battery pack interface configured to receive a battery pack, the battery pack including a plurality of battery cells;
an inverter positioned between and electrically connected to the battery pack interface and the motor;
a gate driver connected to the inverter, the gate driver configured to control a current in the inverter;
a controller configured to control the gate driver; and
a short circuit detection circuit configured to:
monitor the current in the inverter,
compare the current in the inverter to a short circuit threshold, and
control a switch of the short circuit detection circuit to disable the gate driver when the current in the inverter is greater than or equal to the short circuit threshold.

2. The power tool of claim 1, wherein the short circuit detection circuit includes a threshold adjuster for adjusting the short circuit threshold.

3. The power tool of claim 1, wherein the battery pack interface is configured to receive a first power tool battery pack and a second power tool battery pack.

4. The power tool of claim 3, wherein the first power tool battery pack and the second power tool battery pack are configured to be connected in series.

5. The power tool of claim 1, wherein the short circuit detection circuit further includes an overcurrent condition comparator and an undervoltage condition comparator.

6. The power tool of claim 1, where the short circuit detection circuit is further configured to provide a signal to the controller when the current in the inverter is greater than or equal to the short circuit threshold.

7. The power tool of claim 1, where the short circuit detection circuit is further configured to:
monitor a voltage of the power tool,
compare the voltage to an undervoltage threshold, and
control the switch of the short circuit detection circuit to disable the gate driver when the voltage is less than or equal to the undervoltage threshold.

8. The power tool of claim 1, wherein the short circuit detection circuit is further configured to disable the gate driver for a period of time after the current in the inverter is greater than or equal to the short circuit threshold.

9. The power tool of claim 1, wherein the short circuit detection circuit is further configured to:
latch the gate driver active, and
unlatch the gate driver to disable the gate driver.

10. The power tool of claim 1, where the short circuit detection circuit is further configured to:
monitor a second current related to the battery pack;
monitor a third current related to the battery pack;
control the switch of the short circuit detection circuit to disable the gate driver when the second current is greater than or equal to the short circuit threshold, and
control the switch of the short circuit detection circuit to disable the gate driver when the third current is greater than or equal to the short circuit threshold.

11. A method for short circuit detection in a power tool, the method comprising:
measuring, with a current sensor, a current in an inverter;
receiving a fault signal related to a fault condition of a gate driver or the inverter of the power tool;
adjusting, with a threshold adjuster, a fault threshold based on the fault signal to generate an adjusted fault threshold;
comparing the current in the inverter to the adjusted fault threshold to identify a short circuit condition of the power tool; and
disabling the gate driver of the power tool in response to identifying the short circuit condition.

12. The method of claim 11, further comprising:
disabling a trigger signal of the power tool in response to identifying the short circuit condition of the power tool.

13. The method of claim 11, further comprising:
disabling the gate driver of the power tool for a period of time after identifying the short circuit condition.

14. The method of claim 11, further comprising:
latching the gate driver active; and
unlatching the gate driver to disable the gate driver.

15-18. (canceled)

19. A power tool comprising:
a housing;
a motor supported by the housing;
a battery pack interface configured to receive a battery pack, the battery pack including a plurality of battery cells;
an inverter positioned between and electrically connected to the battery pack interface and the motor;
a gate driver connected to the inverter, the gate driver configured to control a current in the inverter;
a controller configured to control the gate driver; and
a short circuit detection circuit configured to:
determine a voltage related to the battery pack,
determine a short circuit overcurrent threshold based on the voltage related to the battery pack,
monitor the current in the inverter,
compare the current in the inverter to the short circuit overcurrent threshold, and
control a switch to disable the motor when the current in the inverter is greater than or equal to the short circuit overcurrent threshold.

20. The power tool of claim 19, wherein the battery pack interface is configured to receive a first power tool battery pack and a second power tool battery pack.

21. The power tool of claim 20, wherein the first power tool battery pack and the second power tool battery pack are configured to be connected in series.

22. The power tool of claim 19, wherein the short circuit overcurrent threshold is selected from a plurality of stepped short circuit overcurrent thresholds based on the voltage related to the battery pack.

23. The power tool of claim 22, wherein the voltage related to the battery pack is a direct current (“DC”) link bus voltage.

24. The power tool of claim 19, wherein the short circuit detection circuit is further configured to:
start a timer after the current in the inverter is greater than or equal to the short circuit overcurrent threshold;
compare the timer to a timer threshold; and
control the switch of the short circuit detection circuit to disable the motor when the current in the inverter is greater than or equal to the short circuit overcurrent threshold and the timer is greater than or equal to the timer threshold.

25-30. (canceled)
